(19) United States
(12) Patent Application Publication
(10) Pub. No.: US 2017/0293985 A1
(43) Pub. Date: Oct. 12, 2017

(54) WEARABLE COMPUTING DEVICE AND METHOD FOR CROWD CONTROL

(71) Applicant: TAG TEAM (WORLD) MALTA LIMITED, Ricasoli SCM (MT)

(72) Inventors: Mohammed Yusuf DERIA, Romford, Essex (GB); Ahmed Mohamed MOHAMOUD, London (GB)

(21) Appl. No.: 15/514,095

(22) PCT Filed: Nov. 4, 2014
(86) PCT No.: PCT/GB2014/053283

§ 371 Date: Mar. 24, 2017

(30) Foreign Application Priority Data
Sep. 26, 2014 (GB) 1417048.4

(51) Int. Cl. G06Q 50/14; G06Q 50/26; G06F 17/30; G08B 25/00

(52) U.S. Cl. CPC G06Q 50/14; G08B 25/006; G06Q 50/26; G06F 17/3087; H04W 4/021

(57) ABSTRACT

The occupancy-control device includes a locating element for determining a location of the occupancy-control device, a movement-determining element for determining whether the occupancy-control device is moving beyond a predetermined distance parameter, and a timer element. An instructing element is also provided by which a movement-instructing signal is outputable, and a logic element is included in communication with the locating element and the movement-determining element which determines whether the occupancy-control device is stationary within a predetermined activation area. A movement-instructing signal is outputable by the instructing element based on said determination and an elapsed period of the timer element. A method of encouraging motion of a plurality of people within a crowd using such devices is also provided.

### RELATED APPLICATION

This application is based on prior filed copending International Application No. PCT/GB2014/053283 filed Nov. 4, 2014, which claims priority to Great Britain Application No. 1417048.4, filed Sep. 26, 2014, the entire subject matter of these applications is incorporated herein by reference in its entirety.

### TECHNICAL FIELD

The present invention relates to an occupancy-control device which is location-based and which encourages motion of a person, particularly forming part of a group of people and more particularly forming part of a large or dense crowd. The invention aims to provide location-based instructions, and a method of use for such a device. Additionally, the present invention relates to an occupancy-control device for remotely providing real-time occupancy information to said person in relation to an attraction, along with a method of use for such a device.

### BACKGROUND

The Hajj is an annual Islamic pilgrimage to the holiest city in the religion of Islam, Mecca, a city in Saudi Arabia. Hajj takes place once every Islamic year and lasts for five consecutive days, from the 8^{th} to the 12^{th} days of Dhu al-Hijjah. During this period, Muslims from all over the world make the journey to Mecca, in order to fulfil one of the Five Pillars of Islam. In recent years, the numbers of pilgrims has grown substantially, from 1.9 million in 1996 up to a peak of 3.2 million in 2012. This number is expected to continue growing in the coming years, and surpass 4 million pilgrims in total.

During the five day pilgrimage of Hajj, pilgrims are expected to carry out a number of religious rites. This requires them to follow a set path, visiting a number of sites of religious and historical significance. Some of these sites are within enclosed spaces, which can result in significant problems due to overcrowding.

Along with Hajj, the same pilgrimage can also be made at other times of the year, and is then referred to as Umrah. Whilst the number of pilgrims performing Umrah is generally much lower than that which occurs during Hajj, it is still substantial, and can lead to similar problems.

One particular site results in crowding problems unlike any other. Al-Masjid al-Haram is the largest and most sacred mosque in the world, and houses the Kaaba, a cuboidal building with special religious significance; the point towards which all Muslims face when praying. During the pilgrimages of Hajj and Umrah, each pilgrim must circumambulate the Kaaba seven times. Unsurprisingly, the concurrent circumambulation of the Kaaba by up to two million pilgrims at any one time can result in problems. This issue is again expected to be exacerbated over time due to the increasing numbers attending.

One such problem is created by pilgrims who stop during a circumambulation and proceed to pray or carry out other, typically stationary, activities within the confines of al-Masjid al-Haram. Stationary persons inhibit the flow of people around the Kaaba, and therefore, security and police personnel are required to attend to any obstructions. Reports indicated that, in 2013, 700,000 security personnel were brought in to deal with the crowds at Hajj.

Whilst there are signs at specific points within al-Masjid al-Haram, indicating that pilgrims should not remain stationary, these signs are typically only written in a certain number of languages, such as Arabic, English, Urdu and Turkish. The ever-growing numbers of foreign pilgrims, many of whom do not speak or have only a very limited understanding of these languages means that the signs have limited effect. Security and police personnel may also only speak Arabic and perhaps a small amount of English or the other above-mentioned languages, and therefore instructions given by such staff may not be understood, and therefore may be ignored, by those to whom the instructions are addressed.

A second problem to be addressed is that of limiting crowding both within and outside of both al-Masjid al-Haram and al-Masjid al-Nabawi, a mosque in the city of Medina, which houses the tomb of Mohammed. This second mosque is often visited by pilgrims, who wish to visit the tomb whilst relatively close by, though it is not a necessary part of the Hajj pilgrimage.

Each of the mosques necessarily has a maximum allowable occupancy, to limit overcrowding, and therefore ensure the safety of the occupants. At the point at which the mosques become full, there is no way of pilgrims being remotely notified, and many more still arrive, only to be informed on arrival that they are not permitted entry. This can result in many thousands gathering outside of al-Masjid al-Haram and al-Masjid al-Nabawi, causing further issues with crowd control, that must be dealt with by way of police and security services.

### SUMMARY

All of the above issues of overcrowding lead unfortunately to deaths of visitors due to crushing and suffocation, as well as less severe injuries requiring hospitalisation. It is an object of the present invention to create a device for preventing or limiting these problems and, additionally, methods of using such a device.

According to a first aspect of the invention, there is provided an occupancy-control device comprising: a locating element for determining a location of the occupancy-control device; a movement-determining element for determining whether the occupancy-control device is moving beyond a predetermined distance parameter; a timer element, and an instructing element by which a movement-instructing signal is outputable; characterised by a logic element in communication with said locating element and the movement-determining element which determines whether the occupancy-control device is stationary within a predetermined activation area, a movement-instructing signal being outputable by the instructing element based on said determination and an elapsed period of the timer element.

Preferable and/or optional features of the first aspect of the invention are set forth in claims 2 to 11, inclusive.

According to a second aspect of the invention, there is provided a method of encouraging motion of a plurality of people within a crowd, the method comprising the steps of: a] providing an area comprising at least one activation region; b] providing the plurality of people each with a user-specific occupancy-control device in accordance with the first aspect of the invention; c] the occupancy-control device determining when each associated person is stationary within said at least one activation region for a predetermined activation period; and d] the occupancy-control device outputting instruction to said associated person to engender movement away from, or within, the activation region following elapse of the said predetermined activation period.

Preferable and/or optional features of the second aspect of the invention are set forth in claims 14 to 21, inclusive.

According to a third aspect of the invention, there is provided an occupancy-control device comprising: a locating element for determining a location of the occupancy-control device; and an occupancy-indication element for output of an occupancy-indication signal; characterised by wireless communication means for the receipt of real-time occupancy information from a venue with a predetermined maximum allowable occupancy; the occupancy-indication element capable of transmitting an occupancy-indication signal based on received real-time occupancy information via the wireless communication means.

Preferable and/or optional features of the third aspect of the invention are set forth in claims 23 to 26, inclusive.

According to a fourth aspect of the invention, there is provided a method of real-time occupancy control of a venue, the method comprising the steps of: a] providing at least one venue with a predetermined maximum allowable occupancy; b] providing a person with an occupancy-control device in accordance with the third aspect of the invention; c] the occupancy-control device determining in real-time if said venue is at its maximum allowable occupancy; and d] the occupancy-control device outputting an occupancy-indication signal to the associated person when said venue is at its maximum allowable occupancy.

Preferable and/or optional features of the fourth aspect of the invention are set forth in claims 29 to 34, inclusive.

Preferably, the occupancy-control device further comprises programmable memory for programming the occupancy-control device with a spoken language of the person. This allows the instructions to be given in a language of the person, which would aid their understanding.

Beneficially, the aforementioned instructing element includes a speaker. The inclusion of a speaker allows aural instructions to be made. Additionally, this would enable instructions to be vocalised, which would preferably be in a spoken language of the person. In this way, a verbal output from the occupancy-control device would be easily understandable irrespective of nationality and/or citizenship.

Furthermore, the instructing element could include a vibration-producing portion, for the outputting of instructions as a vibration. These vibrations would be easily felt by the person, if the occupancy-control device is in contact with their body. This would enable instruction even when the surrounding environment is too loud to hear aural instructions.

Beneficially, the occupancy-control device further includes wireless communication means for the receipt of real-time occupancy information from an attraction with a maximum allowable occupancy; the instructing element capable of transmitting an instructing signal based on received real-time occupancy information received by the wireless communication means.

Preferably, the method above comprises an additional step wherein the occupancy-control device is programmed with a spoken language of the person. Additionally, the occupancy-control device can provide the instruction as a vocalisation, and preferably in the spoken language of the person. Therefore, the person will have a better opportunity of being able to understand the instructions.

The instruction could also be by way of a vibrating alert. This would enable the instruction to be felt by the person, which is advantageous if their environment is too loud to hear aural instructions. Beneficially, the vibrating alert could be combined with an aural alert, in order that the vibration alerts the person to the presence of an incoming instruction, and that they can therefore listen out for the instruction itself. Alternatively, the instruction could be solely given by vibration, whereby an individual instruction is allocated a specific pattern of vibrations, which can be translated into the required action by the user.

Preferably, the method can further include the steps of: providing at least one area with a predetermined maximum allowable occupancy; the occupancy-control device determining the closest area with a maximum allowable occupancy; the occupancy-control device determining if said area is at its maximum allowable occupancy; and the occupancy-control device outputting instruction to the person when said area is at its maximum allowable occupancy.

By including these additional steps, the occupancy-control device can provide further information to a user about whether an area has any room for further occupants. For example, al-Masjid al-Haram might have a maximum allowable occupancy of two-million people, and at the point at which this occupancy is reached, the device will instruct the person not to travel to the mosque, as they will not be allowed entry. This will prevent or limit crowding from occurring outside the mosque at busy times.

Preferably, the device transmits one instructing signal when the venue or attraction is at its maximum allowable occupancy and another, different, instructing signal when the attraction is not at its maximum allowable occupancy.

Beneficially, the instructing element comprises at least one light-emitting element. Furthermore, the instructing element could comprise two, differently coloured light-emitting elements, with the lighting-up of different colours relating to different instructions.

Beneficially, the occupancy-control device further comprises a movement-determining element, for determining whether the occupancy-control device is moving; and a logic element, in communication with the locating element and movement-determining element, which determines whether a user is stationary within a predetermined activation area and causes an instructing element to transmit an indicator signal based on said determination.

Preferably, the occupancy-control device determines whether the venue or area is at its maximum allowable occupancy by receipt of a signal from the area. Receipt of a signal would ensure up-to-date information is being communicated by the device.

Additionally, the occupancy-control device could output a different instruction when the area is not at its maximum allowable occupancy. Information would therefore be communicated at all times, which would enable a person to know that the occupancy-control device is working, and provide them with knowledge of the occupancy situation at any given time.

Preferably, the information can be communicated by way of light signals, such as, for instance, light-emitting diodes or other suitable light-emitting element. In this way, the shining of an LED can communicate the necessary instruction, but in a way that is viewable at any time, rather than only at a specific moment.

Furthermore, the method could include the steps of: providing an area comprising at least one activation region; the occupancy-control device determining when the person is stationary within an activation region for a predetermined activation period; and the occupancy-control device outputting information to said person to engender movement away from, or within, the activation region.

Addition of the extra steps would allow the device to make use of the information as described in the first aspect of the invention.

### BRIEF DESCRIPTION OF THE DRAWINGS

The invention will now be more particularly described, by way of example only, with reference to the accompanying drawings, in which:

FIG. 1 is a perspective view of a first embodiment of an occupancy-control device, in accordance with the first aspect of the invention;

FIG. 2 is a generalised block diagram of the electronic circuits forming at least part of occupancy-control device shown in FIG. 1;

FIG. 3 is a generalised flow-chart of the decision-making logic process of the occupancy-control device;

FIGS. 4a to 4d are diagrammatic depictions of four different scenarios of the in use occupancy-control device;

FIG. 5 is a perspective view of a second embodiment of an occupancy-control device, in accordance with the third aspect of the invention; and

FIG. 6 is a perspective view of a third embodiment of an occupancy-control device, in accordance with the first and third aspects of the invention.

### DETAILED DESCRIPTION

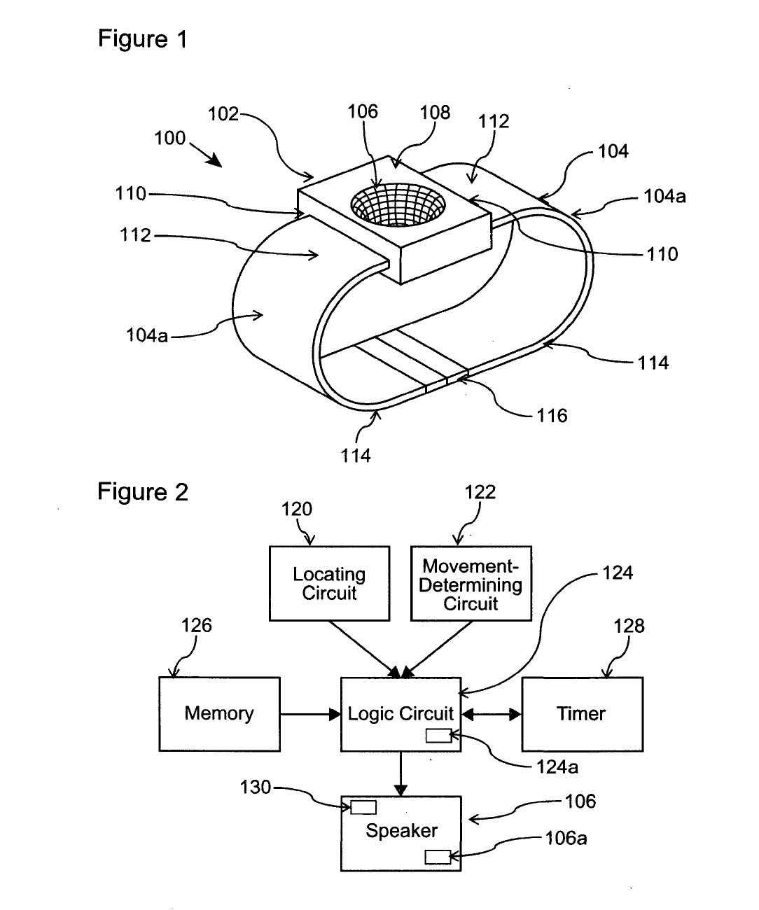

Referring firstly to FIG. 1, there is shown a first embodiment of an occupancy-control device, indicated globally as 100, which comprises a housing 102, strap 104, and instructing element, which in the present embodiment is or includes a speaker 106.

The housing 102 is preferably cuboidal in shape, with in this embodiment square upper and lower surfaces 108 and rectangular lateral side surfaces 110 there around. Although preferably cuboidal, any other suitable polygonal, circular or non-circular housing may be utilised. The occupancy-control device 100 may also be incorporated as part of another form of wearable technology, such as a wearable mobile computing device or so-called ‘smart watch’, for example.

On the upper surface 108 of the housing 102 is positioned the speaker 106, thereby enabling a more direct or directionally-focussed audible output to the user. However, the speaker or speakers may be incorporated additionally or alternatively in the sides and/or back of the housing 102, as necessity dictates.

The strap 104 comprises two releasably interengagable strap parts 104a which are, preferably, elongate strips of rubber, leather or other such pliable or flexible material. The two strap parts 104a are each attached at or adjacent to their respective proximal ends 112 to one of two opposing lateral side surfaces 110 of the housing 102. Distal ends 114 of each strap part 104a are looped together and releasably fastened using a clasp 116, thus creating an endless strap 104, which can be, preferably length-adjustably, looped around the wrist of a user.

Referring to FIG. 2 representatively showing the internal circuitry of the occupancy-control device 100, a locating circuit 120 gathers location data, using a position determining system such as GPS or GLONASS. The gathered location data is used to determine the user's specific geographical position. A movement-determining circuit 122 determines whether the occupancy-control device 100 is, or is not, moving, for example, by incorporating a parameter-defined accelerometer. By pre-setting movement parameter data, an extent of user movement can be determined. For instance, if the user is waving the occupancy-control device 100 around their head, for example, to attract a third-parties attention, the movement-determining circuit 122 can distinguish this movement due to its limited range and velocity from the movement associated with ambulatory movement.

A logic circuit 124 analyses the data gathered by the locating circuit 120 and the movement-determining circuit 122 which is fed thereto.

Firstly, the logic circuit 124 utilises the location data gathered by the locating circuit 120 to determine whether the user is within an activation region. Activation regions could be stored within an electronic memory 126 of the occupancy-control device 100, or alternatively or additionally could be received wirelessly using a wireless transceiver, which is not shown in this embodiment. The logic circuit 124 utilises data from the movement-determining circuit 122, which determines whether or not the user is moving beyond the pre-set movement parameters.

By the use of the data from the locating circuit 120 and the movement-determining circuit 122, the logic circuit 124 determines if a timer or timer circuit 128 should be activated. The timer 128 is activated in order to time how long a user is stationary within the aforementioned activation region. The activation period is pre-set, and stored within the memory 126. In this case, the activation period is pre-set to three minutes, for example, but other periods can be utilised as required. However, it is preferable that the activation period is not user-adjustable, and consequently is pre-set during manufacture or by the supplier of the device 100 to the user. In any event, in this example, after three minutes expires, the logic circuit 124 outputs an activation signal to an instruction circuit 124a by which instruction signals are outputted to a driver circuit 106a of the speaker 106, whereby a verbal output is generated to provide an instructional command to the user.

In this case, the outputted instruction is a vocalisation, which is pre-stored within the memory 126 and then sounded by the speaker 106.

The memory 126 can advantageously be programmed or preloaded with a spoken language of the person, in order that instructions sounded by the speaker 106 can automatically be given in said spoken language. Preferably, the device 100 is pre-programmed with the user's preferred language at the embarkation point of the user into the country being visited. This is convenient, since a user typically has to organise a visa to permit entry and travel within the country, and must pass through passport control. At this point, the device 100 which has been configured for the user can be collected. However, other options are envisaged, such as having the device 100 pre-configured and pre-sent to the user prior to disembarkation from their country of residence; having the device 100 pre-configured and pre-sent to the user's accommodation in the country being visited; or having the device 100 configured as part of a mobile computing device, such as a telecommunications device or so-called ‘smart phone’, whereby the necessary language instructions are downloadable via the Internet or other suitable multi-computer data-communications network in the form of a computer-implemented application programme or so-called ‘app’.

The outputable instruction, whilst in this embodiment provided by a speaker 106, could also be provided by way of a vibration, light signal or other alert which can be sensed by a user, by way of a vibration-producing portion, light, or other such element, respectively.

In the case of verbalised instructions, the device 100 is pre-programmed with a range of standard instructions in the user's preferred language which may increase in severity dependent on the time elapsed through non-movement, such as but not limited to: ‘Please continue to move.’; ‘You should now move.’; ‘By not moving on, you are obstructing others.’; ‘You must move now or the authorities will be called!’; ‘The authorities have been summoned to forcibly move you, and this may be subject to a monetary fine!’ and so on.

If the user is determined by the locating circuit 120 or movement-determining circuit 122 to have moved within this period, the timer 128 will reset, and the timer 128 will begin timing again from zero. Otherwise, the severity of the warnings preferably increases.

In the event that a user is non-compliant with the movement requests of the device 100, then a transmitter circuit 130 within the housing 102 outputs a movement-request signal to the local authorities, typically being the police, security guards, wardens and/or army contracted or enlisted to monitor the crowded area. The movement-request signal would preferably include location data as determined by the locating circuit 120 to enable the relevant third party to quickly locate and forcibly usher the user of the device 100 onwards, and/or to issue a monetary penalty notice or fine, if required, for example.

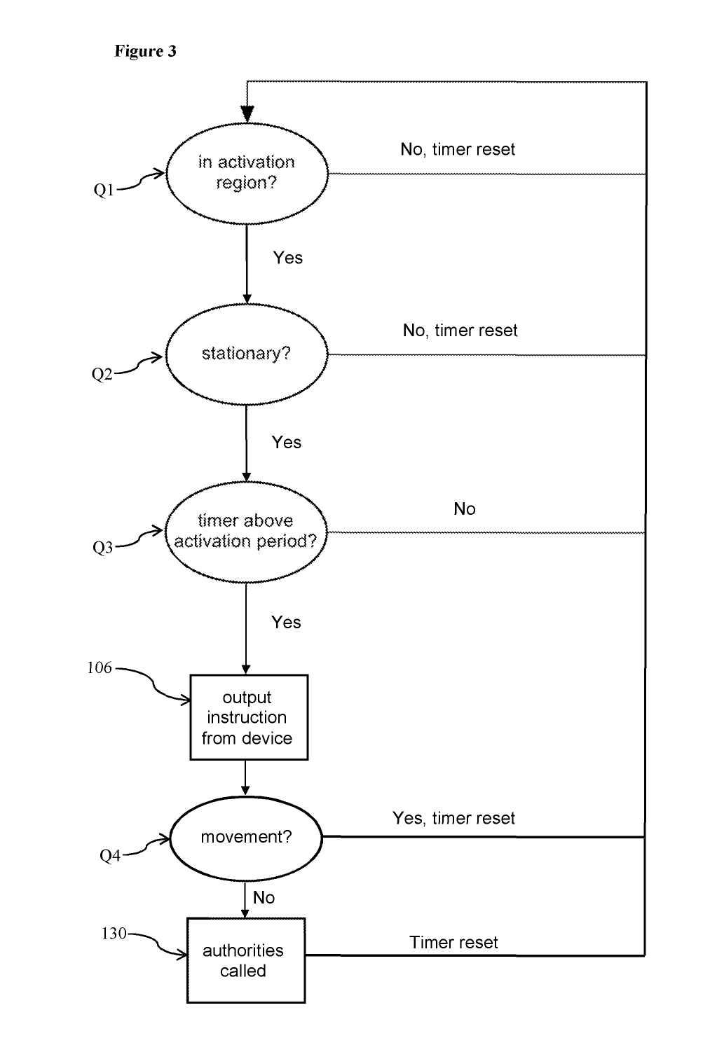

With regard to FIG. 3 a decision-making or logic process of the logic circuit 124 consists of or includes at least four queries Q1, Q2, Q3, Q4, which are each considered in turn. After each query Q1, Q2, Q3, Q4 is answered, the relevant instruction is sent to the timer 128, which is either reset, or continues counting. Once the timer 128 rises above the activation period, an instructional command driver signal is sent to the speaker 106, which then outputs the instruction, and/or summons the local authorities. The logic process is explained in more detail hereinbelow.

Although an option to summon the authorities is preferred, it is an optional feature.

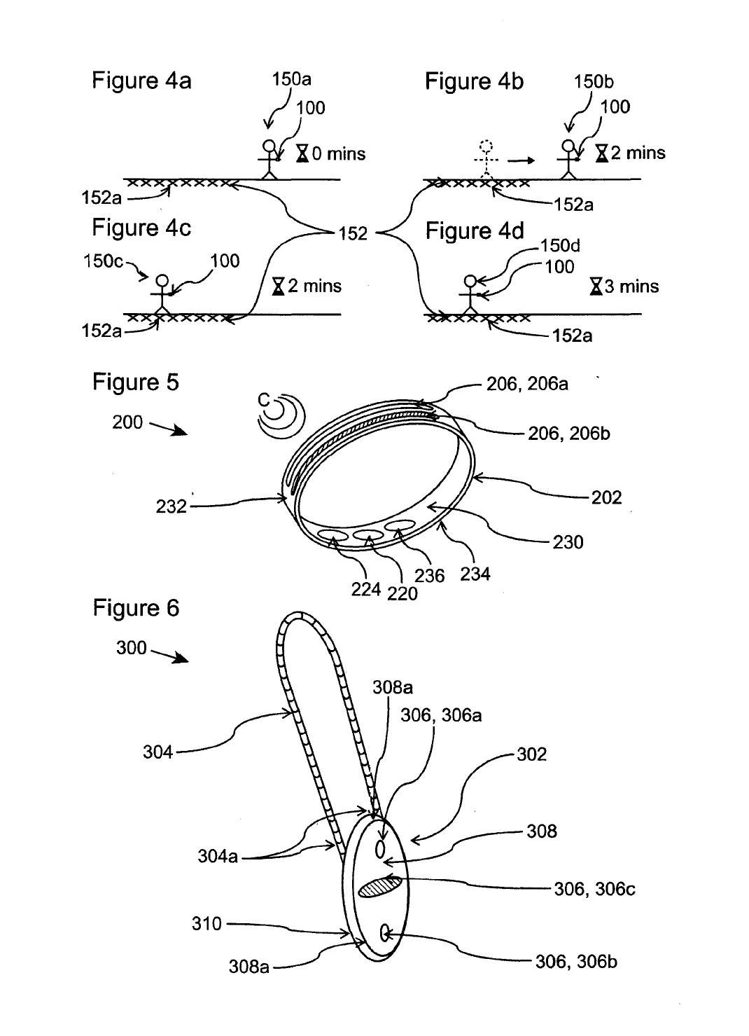

Different scenarios of a person using the occupancy-control device 100 are shown in FIGS. 4a to 4d. In each scenario, there is depicted a person 150a to 150d and an activation area 152.

FIG. 4a depicts a person 150a standing outside an activation region 152 with the device 100 on their wrist. The activation region 152 may be defined by sensors 152a embedded within the ground, and/or by one or more transmitter towers with a predefined range, not shown in this case. If required, the device 100 may include a suitable receiver other than the locating circuit 120, for example, if receipt of radio frequency transmission from the said towers or sensors is required, for example, instead of or to supplement the position determination of the locating circuit 120.

The timer 128 is permanently at zero minutes, and will not start timing until the person 150a enters the activation region 152. Q1 in FIG. 3. Therefore the speaker 106 will not sound.

FIG. 4b shows a person 150b who has just spent two minutes within the activation region, but has now moved, represented by the phantom lines, and thus detected by locating circuit 120, movement-determining circuit 122 and logic circuit 124. Q2 in FIG. 3. The timer 128 counts to two minutes, but instantaneously then resets, thus preventing the speaker 106 from sounding until the person 150b has been stationary as defined by the pre-set parameters mentioned above within the activation region 152 for a further three minutes.

FIG. 4c shows a person 150c who is stationary within the activation region 152, and has been within the activation region 152 for two minutes. Again, Q2 in FIG. 3. The speaker 106 will not sound until after the person has been within the activation region 152 for a further one minute without movement as defined by the pre-set parameters of the movement-determining circuit. Q3 in FIG. 3.

FIG. 4d shows a person 150d who has been stationary within the activation region 152 for three consecutive minutes. Again, Q3 in FIG. 3. The speaker 106 will therefore begin to sound, giving a vocal instruction in the language of the person for the person 150d to move within, or away from, the activation region 152. Providing there is then movement detected by the movement-determining circuit 122 outside of the pre-set parameters (Q4 in FIG. 3), the timer 128 resets. Otherwise, the authorities are summoned via transmitter circuit 130.

FIG. 5 depicts a second embodiment of an occupancy-control device, indicated globally as 200 and which comprises a housing 202 and two elongate instructing elements 206. In this embodiment, similar references are utilised for similar parts, and therefore further detailed description is omitted.

The housing 202 may be formed as a circular ring, comprising an inner surface 230, outer surface 232 and two lateral side surfaces 234 joining said inner and outer surfaces 230, 232 together. The housing is made of a suitable material for being worn by a person, such as stainless steel or poly(vinyl chloride), for example. The occupancy-control device 200 is sized so as to be suitable for wearing on a person's wrist. However, other attachment means may be considered for attaching any of the embodiments described herein, providing the device is locatable on the user. For example, a lanyard, necklace, belt, shoe, insole, and/or as already mentioned a computer programme executable on a user's personal or business mobile or portable computing device.

The two elongate instructing elements 206 are embedded in the outer surface 232 of the housing 202, parallel to one another and extending preferably circumferentially along approximately 25% of the circumference of the housing 202. Each instructing element 206 is a light-emitting diode, although any other suitable light-emitting element can be utilised, such as an electro-luminescent element. One instructing element 206a is preferably a green light-emitting diode, and the other instructing element 206b is preferably a red light-emitting diode.

In this way, the occupancy-control device 200 can, in use, instruct the wearer that a venue, such as a visitor attraction and/or pilgrimage site, has not reached its maximum allowable occupancy by lighting up the green instructing element 206a. Alternatively, the occupancy-control device 200 can, in use, instruct the person that the attraction has reached its maximum allowable occupancy by lighting up the red instructing element 206b.

The occupancy-control device 200 determines whether the attraction has reached its maximum allowable occupancy by receipt of a signal received to a receiver circuit 236 onboard by a wireless communication means C, such as a cellular radio station broadcasting occupancy signal data. Such a signal would be broadcast from an attraction, or by a person or electronic device monitoring such an attraction.

Advantageously, the occupancy-control device 200 can receive occupancy information from more than one attraction. The device 200 can then determine the closest attraction utilising its locating circuit 220 and logic circuit 224, and then energise the instructing elements 206 as required via an onboard power supply, such as a, preferably rechargeable, battery to give information based on the closest attraction. In this case, it is foreseen that the instructing elements 206 can provide different signals based on for which attraction the information is being provided.

Whilst the instructing elements 206 of this second embodiment are two light-emitting diodes, it would be possible to only have one light-emitting element that gives different instructions by way of being able to emit different colours or different patterns of flashing light, for instance. Alternatively or additionally, the instructions could be given by sound or vibration, in which case the instructing element or elements would be speakers or vibrating elements, respectively. Furthermore, the instructions could be communicated by any other signal which a person could sense.

A third embodiment of an occupancy-control device is indicated globally as 300 in FIG. 6. Again, similar references are utilised for parts which are similar to those of the preceding embodiments, and therefore further detailed description is omitted.

The occupancy-control devices in the foregoing embodiments have initially been described as separate functional items. However, the third embodiment of the locating occupancy-control device 300 shows that it is advantageous to provide both motion instructions and occupancy instructions within the same device, such that a person receives all the available information about an attraction.

The occupancy-control device 300 has a housing 302, comprising, preferably oval, front and rear surfaces 308 and a continuous lateral side surface 310 connecting the front and rear surfaces 308 together. A lanyard 304 is utilised in this case in place of a wrist strap, and provides an elongate element with a generally circular or flat lateral cross-section. Two ends 304a of the lanyard 304 are connected to the rear surface 308 of the housing 302 and/or at the side surface 310. The lanyard 304 is of a length suitable for hanging the housing of occupancy-control device 300 around the neck of a person, and as such may be in the order of 50 centimetres in length. Again, however, the lanyard connection means is purely optional, device 300 may utilise the wrist strap as described above, or any other suitable user location means.

Positioned on the upper surface 308 of the housing 302 are, in this case, preferably three instructing elements 306. Two of the instructing elements 306a, 306b are positioned towards opposing ends 308a of the upper face 308 and take the form of light-emitting elements, similarly to those described above. The third instructing element 306c takes the form of a speaker, again similarly to that described above, and is positioned preferably centrally between the two light-emitting diode instructing elements 306a, 306b on the front surface 308. In use, the two light-emitting diode instructing elements 306a, 306b, for example being LEDs, indicate whether an attraction has reached its maximum allowable capacity, as discussed in the second embodiment. These instructions are given by flashing of the light-emitting diode instructing elements 306a, 306b. The third instructing element 306c performs similarly to the speaker 106 described in the first embodiment and with reference to FIG. 1, whereby the speaker 106 outputs a vocalised or otherwise audible instruction to the person in order to instruct a movement within or away from an activation region.

The instructing elements 306 described above are light-emitting diodes or speakers, but could also take the form of vibrating elements, or other methods of alerting or instructing a person using sight, sound, or touch transducers.

The form of each occupancy-control device, whilst limited in the embodiments to wrist-wearable or neck-wearable devices, could also be wearable in other ways as alluded to above, such as being ankle-mounted, or built in to an item of clothing. Alternatively, it is foreseeable for an occupancy-control device to be designed for carrying in a pocket of an item of clothing, within a bag or other carrying device, or attachable to a belt, in order to allow easy carrying for a person.

The locating circuit is described above as utilising GPS or GLONASS (registered trademarks where appropriate are acknowledged herein and throughout) and is therefore capable of determining absolute position of the occupancy-control device on which it is mounted. However, it would also be reasonable to anticipate the locating circuit to be location-determinable such that it can determine its location relative to another object, additionally or alternatively to the use of the examples of GPS or GLONASS. For instance, the locating circuit could comprise a radio receiver which detects radio waves from a transmitter positioned within an activation region, and/or may be Internet enabled or otherwise communicable with like-devices 100, 200, 300, particularly in close proximity such that localised dense over-crowding within a larger crowd or group of people can be managed more proactively by the like-devices intercommunicating and using predetermined logic in the respective logic circuits to promote movement and dispersion of the localised over-crowding within the mass of visitors. To this end, the timer circuit may be dynamically adaptable in real time by the logic circuit dependent on crowd data feedback or input into the device via a receiver circuit from the other devices in close proximity. Furthermore, the locating circuit would preferably recognise the activation region by the strength of the detected radiation, and consequently more accurately the user's position and importantly progress through the activation region. Again, the timer circuit may thus be adaptable in real time dependent on the numbers of visitors within the activation region to alter the timer period based on the strength of the detected radiation and consequently position within the activation region. It is anticipated that a person skilled in the art would be able to foresee other possible methods of geographical location-determination, be that either absolute location or relative location, in order to achieve the same result as described above.

Although the embodiments each describe the device as being specifically designed for the functions of the present invention, it is also foreseeable to utilise a device such as a mobile phone or other consumer electronic device, which comprises the individual components necessary, to perform the desired function, by way of an application or other software. In this case, one or more of the circuits described above, for example, the logic circuit may be replicated or emulated in software code and thus effectively downloadable to a user's device as a logic unit for execution and interaction with other required components or units built into the user's mobile computing device, such as the location circuit or unit and the movement-detection circuit or unit.

Consequently, herein and throughout, the term ‘circuit’ is intended to encompass ‘unit’, ‘element’ and/or ‘module’, and vice versa, and is not intended to be limited or solely limited to physical circuitry.

It is therefore possible to provide a device for providing instructions to a person, particularly when they are in a throng or mass of visitors attending an event, related to their geographic location and motion at any particular time. Along with this, it is possible to provide a device that provides instructions to a person based on information determined about whether an attraction is at its maximum allowable capacity. Furthermore, it is shown that it is possible to provide one device which can provide both motion instructions and capacity instructions. In particular, it is possible, when a plurality of people are using the afore-described devices to prevent or limit overcrowding at a venue, along with encouraging or controlling the flow of said people through or within the said venue. As such, the hazards associated with such visits can be entirely or significantly mitigated, leading to a far safer environment for visitors, and in particular the young, elderly, disabled, and infirm.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. An occupancy-control device comprising:
a locating element which determines a location of the occupancy-control device;
a movement-determining element which determines whether the occupancy-control device is moving beyond a predetermined distance parameter;
a timer element; and
an instructing element adapted to output a movement-instructing signal;
characterised by a logic element in communication with said locating element and the movement-determining element which determines whether the occupancy-control device is stationary within a predetermined activation area, the instructing element being adapted to output the movement-instructing signal based on said determination and an elapsed period of the timer element.

2. The occupancy-control device as claimed in claim 1, further comprising a programmable memory which programs the occupancy-control device with a spoken language of a person.

3. The occupancy-control device as claimed in claim 1, wherein the instructing element includes at least one of: a speaker which outputs the movement-instructing signal, and a vibration-producing portion which outputs the movement-instructing signal as a vibration.

4. The occupancy-control device as claimed in claim 1, wherein the movement-instructing signal is a verbal instruction in a predetermined spoken language of a user.

5. (canceled)

6. (canceled)

7. The occupancy-control device as claimed in claim 1, further comprising a user-wearable housing in which is provided the locating element, the movement-determining element, the instructing element and the logic element.

8. The occupancy-control device as claimed in claim 7, further comprising at least one of: a wrist-strap attached to the user-wearable housing and a lanyard attached to the housing.

9. (canceled)

10. The occupancy-control device as claimed in claim 1, formed as part of a personal mobile computing device, and wherein at least the logic element is formed as a downloadable executable computer application program.

11. (canceled)

12. The occupancy-control device as claimed in claim 1, further comprising a wireless communication system which receives real-time occupancy information from a venue with a predetermined maximum allowable occupancy; the instructing element adapted to transmit the movement-instructing signal based on received real-time occupancy information received by the wireless communication system.

13. A method of encouraging motion of a plurality of people within a crowd, the method comprising the steps of: a] providing an area comprising at least one activation region; b] providing the plurality of people each with a user-specific occupancy-control device as claimed in claim 1; c] the occupancy-control device determining when each associated person is stationary within said at least one activation region for a predetermined activation period; and d] the occupancy-control device outputting instruction to said associated person to engender movement away from, or within, the activation region following elapse of the said predetermined activation period.

14. The method as claimed in claim 13, comprising an additional step between steps b] and c], wherein the occupancy-control device is programmed with a spoken language of the person and the instruction is by way of one or more verbal commands in said spoken language of the person.

15. (canceled)

16. (canceled)

17. The method as claimed in claim 13, wherein the instruction is or includes a vibrational alert.

18. The method as claimed in claim 17, further including the steps of: e] providing at least one venue with a predetermined maximum allowable occupancy; f] the occupancy-control device determining if said venue is at its maximum allowable occupancy; and g] the occupancy-control device providing an output to a user when said area is at its maximum allowable occupancy.

19. The method as claimed in claim 18, further comprising a step between steps e] and f], when there is more than one said venue, of the occupancy-control device determining the closest said venue to the occupancy-control device.

20. The method as claimed in claim 13, further comprising a step of outputting a request signal to a local authority to assist with movement of the associated person, if user movement is not determined in step d] following elapse of the predetermined activation period.

21. The occupancy-control device as claimed in claim 12, further comprising an occupancy-indication element which outputs an occupancy-indication signal, the occupancy-indication element adapted to transmit the occupancy-indication signal based on received real-time occupancy information via the wireless communication system.

22. The occupancy-control device as claimed in claim 21, wherein a first occupancy-indication signal is transmittable when the venue is at its maximum allowable occupancy, and a second occupancy-indication signal which is different to the first occupancy-indication signal is transmitted when the venue is not at its maximum allowable occupancy.

23. The occupancy-control device as claimed in claim 21, wherein the occupancy-indication element comprises at least one of: at least one light-emitting element which outputs a visual signal and two differently-coloured light-emitting elements, wherein the lighting-up of different colours relates to different occupancy data.

24. (canceled)

25. (canceled)

26. A method of real-time occupancy control of a venue, the method comprising the steps of: a] providing at least one venue with a predetermined maximum allowable occupancy; b] providing a person with an occupancy-control device as claimed in claim 21; c] the occupancy-control device determining in real-time if said venue is at its maximum allowable occupancy; and d] the occupancy-control device outputting an occupancy-indication signal to the associated person when said venue is at its maximum allowable occupancy.

27. The method as claimed in claim 26, wherein the occupancy-control device determines whether the venue is at its maximum allowable occupancy by receipt of a signal from the venue.

28. The method as claimed in claim 26, wherein a different occupancy-indication signal is outputted when said venue is not at its maximum allowable capacity, and/or the each occupancy indication signal is provided by way of visual signals.

29. (canceled)

30. (canceled)

31. (canceled)

32. (canceled)
